(19) United States
(12) Patent Application Publication
(10) Pub. No.: US 2025/0249485 A1
(43) Pub. Date: Aug. 7, 2025

(54) Roller Cleaning Apparatus

(71) Applicant: SK On Co., Ltd., Seoul (KR)

(72) Inventors: Dong Young JUNG, Daejeon (KR); Hae Sung GWAK, Daejeon (KR)

(21) Appl. No.: 18/981,914

(22) Filed: Dec. 16, 2024

(30) Foreign Application Priority Data
Feb. 2, 2024 (KR) 10-2024-0016739

(51) Int. Cl. B08B 1/10; B08B 5/02

(52) U.S. Cl. CPC B08B 1/10; B08B 5/02

(57) ABSTRACT

Proposed is a technology of a roller cleaning apparatus. The roller cleaning apparatus includes a first pad configured to remove foreign substances by being in contact with a surface of a roller, a second pad configured to be in contact with the surface of the roller while passing through an area through which the first pad has passed from the surface of the roller, a head configured to fix the first pad and the second pad such that the first pad and the second pad are spaced apart from each other by a predetermined distance, and a driving assembly configured to move the head to a portion of the roller to which foreign substances are attached.

### CROSS REFERENCE TO RELATED APPLICATION

This patent document claims the priority and benefits of Korean Patent Application No. 10-2024-0016739, filed Feb. 2, 2024, the entire contents of which are incorporated herein by reference for all purposes.

### TECHNICAL FIELD

The present disclosure relates to a technology of a roller cleaning apparatus.

### BACKGROUND

In order to manufacture an electrode of a battery cell, a current collector is coated with an active material slurry. The current collector is moved in a roll-to-roll type apparatus, and the slurry may be applied to the current collector in a process in which the current collector is moved in a first direction. A roller that moves the current collector or a roller of a coating machine that applies the slurry to the current collector may be contaminated by foreign substances. When a slurry that is not completely dried or foreign substances such as dust is attached to a surface of the roller, the foreign substances may be transferred to the current collector or the current collector may be damaged.

### SUMMARY

According to an aspect of the disclosed technology of the present disclosure, a roller cleaning apparatus capable of removing foreign substances attached to a surface of a coating roller may be provided.

The roller cleaning apparatus according to an aspect of the disclosed technology of the present disclosure may be applied to a manufacturing process of a battery widely used in green technology fields such as electric vehicles, battery charging stations, and other fields using a battery, such as the solar photovoltaic power generation field, the wind power generation field, and so on.

The roller cleaning apparatus according to an aspect of the disclosed technology of the present disclosure may be applied to a manufacturing process of a battery used in an eco-friendly electric vehicle, a hybrid vehicle, and so on for preventing climate change by suppressing air pollution and the emission of greenhouse gases.

According to an aspect of the disclosed technology of the present disclosure, there is provided a roller cleaning apparatus including: a first pad configured to remove foreign substances by being in contact with a surface of a roller; a second pad configured to be in contact with the surface of the roller while passing through an area through which the first pad has passed from the surface of the roller; a head configured to fix the first pad and the second pad such that the first pad and the second pad are spaced apart from each other by a predetermined distance; and a driving assembly configured to move the head to a portion of the roller to which foreign substances are attached.

According to an embodiment, the roller cleaning apparatus may further include: a nozzle configured to apply a cleaning solution toward an area through which the first pad will pass; and a cleaning solution supply unit configured to supply the cleaning solution to the nozzle.

According to an embodiment, the driving assembly may include: a first driving assembly connected to the head and configured to move the head in a first direction toward the roller; and a second driving assembly connected to the first driving assembly and configured to be moved along a guide frame that extends in a second direction which is a longitudinal direction of the roller.

According to an embodiment, the first pad may include a first jig which is inserted inside the first pad and which supports the first pad, the second pad may include a second jig which is inserted inside the second pad and which supports the second pad, and the first pad and the second pad may be coupled to the first jig and the second jig such that the first pad and the second pad are capable of being attached to and detached from the first jig and the second jig.

According to an embodiment, each of the first jig and the second jig may have each lower end thereof provided with a fastening groove into which a fastener is inserted, and the head may include: a first jig mount configured to fix the first jig such that the first jig is capable of being attached to and detached from the first jig mount; and a second jig mount configured to fix the second jig such that the second jig is capable of being attached to and detached from the second jig mount.

According to an embodiment, each of the first jig and the second jig may have a trench that is concave inwardly and parallel to a first surface of the head, and the roller cleaning apparatus may further include: a first pressing part which is connected to the first jig mount and which has a protrusion part that protrudes toward the trench, the protrusion part being configured to press the first pad covering the first jig, thereby fixing the first pad by pushing the first pad toward an inside of the trench; and a second pressing part which is connected to the second jig mount and which has a protrusion part that protrudes toward the trench, the protrusion part being configured to press the second pad covering the second jig, thereby fixing the second pad by pushing the second pad toward the inside of the trench.

According to an embodiment, the first pressing part or the second pressing part may include: a center body connected to the first jig mount or the second jig mount; a first arm and a second arm that extend along the trench of the first jig or the second jig from opposite sides of the center body; the protrusion part which is formed on a surface of the first arm and a surface of the second arm that are facing each other and which protrudes toward the trench; and a distance adjustment part formed on an end of the first arm and an end of the second arm and configured to adjust a distance between the first arm and the second arm.

According to an embodiment, the roller cleaning apparatus may further include: an angle adjustment part connected to the first jig mount and the second jig mount and configured to adjust an angle of the first jig and an angle of the second jig with respect to the roller.

According to an embodiment, the angle adjustment part may include: a first hinge configured to adjust an angle of the first jig mount so as to adjust an angle at which the first jig faces the roller; and a second hinge configured to adjust an angle of the second jig mount so as to adjust an angle at which the second jig faces the roller.

According to an embodiment, the angle adjustment part may further include a rail formed curvedly along a circumferential direction of the roller, and the first jig mount and the second jig mount may be coupled to the rail such that the first jig mount and the second jig mount are capable of being moved along the rail and are capable of being fixed to the rail.

According to an embodiment, the rail may be formed such that a curvature of some areas of the rail and a curvature of some other areas of the rail are different from each other.

The features and advantages of the disclosed technology of the present disclosure will be more clearly understood from the following detailed description based on the accompanying drawings.

The terms and words used in the present specification and claims should not be interpreted as being limited to typical meanings and dictionary definitions, but should be interpreted as having meanings and concepts relevant to the technical scope of the disclosed technology of the present disclosure on the basis of the rule according to which an inventor can appropriately define the concept of the term to describe most appropriately the best method he or she knows for carrying out the disclosed technology of the present disclosure.

According to an embodiment of the disclosed technology of the present disclosure, foreign substances on the coating roller may be easily removed, so that the operation rate of manufacturing facility may be increased.

According to an embodiment of the disclosed technology of the present disclosure, a portion where the contamination is repeated may be continuously cleaned.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a roller cleaning apparatus configured to clean a coating roller according to an embodiment;

FIG. 2 is a view illustrating a first pad and a second pad that are in contact with a surface of the coating roller according to an embodiment;

FIG. 3 is a view illustrating the roller cleaning apparatus and a roller according to an embodiment;

FIG. 4 is a view illustrating a pad and a jig according to an embodiment;

FIG. 5 is a view illustrating the jig according to an embodiment;

FIG. 6 is a view illustrating a coupling of the pad, the jig, and a jig mount according to an embodiment;

FIG. 7 is a view illustrating shapes of the jig according to an embodiment;

FIG. 8 is a view illustrating the jig in which a trench is formed according to an embodiment;

FIG. 9 is a view illustrating a coupling of the pad, the jig, the jig mount, and a pressing part according to an embodiment;

FIG. 10 is a view illustrating a relationship between angles of a first jig and a second jig and a diameter of the roller according to an embodiment;

FIG. 11 is a view illustrating a head configured to adjust an angle by using a hinge according to an embodiment; and

FIG. 12 is a view illustrating the head configured to adjust the angle by using a rail according to an embodiment.

### DETAILED DESCRIPTION

Hereinafter, the disclosed technology of the present disclosure will be described in detail (with reference to the accompanying drawings). However, those skilled in the art will appreciate that such embodiments are provided to further understand the spirit of the disclosed technology of the present disclosure and do not limit subject matters to be protected as disclosed in the detailed description and appended claims.

In adding reference numerals to components throughout the drawings, it is to be noted that like or similar reference numerals designate like or similar components even though the components are illustrated in different drawings.

The terms used in the disclosed technology of the present disclosure are used to describe an embodiment, and are not intended to limit the disclosed technology of the present disclosure. Singular expressions include plural expressions unless the context clearly indicates otherwise.

The drawings may be exaggerated or shown schematically for description of an embodiment. In the present disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

The terms “one”, “other”, “another”, “first”, “second”, and so on are used to differentiate one constituent element from another constituent element, and these constituent elements should not be limited by these terms.

It should be understood that, when terms representing directions such as upwards, downwards, left, right, X-axis, Y-axis, Z-axis, and so on are used in the specification, these terms are merely for convenience of description, and such directions may be expressed differently from those represented by the terms, in accordance with the viewing position of an observer or the position at which an object is disposed.

It should be understood that the specific embodiments and accompanying drawings according to the concept of the present disclosure are not limited to the embodiments which will be described hereinbelow. The disclosed technology of the present disclosure should be understood to cover all modifications, equivalents, and/or alternatives of the embodiments.

Hereinafter, an embodiment of the disclosed technology of the present disclosure will be described in detail with reference to the accompanying drawings.

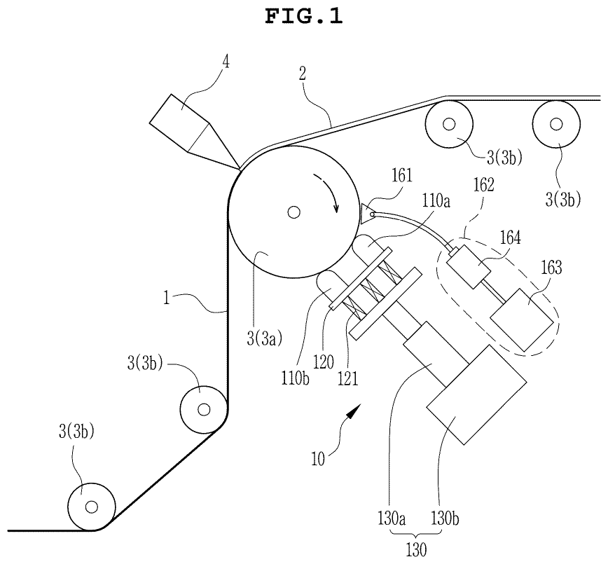

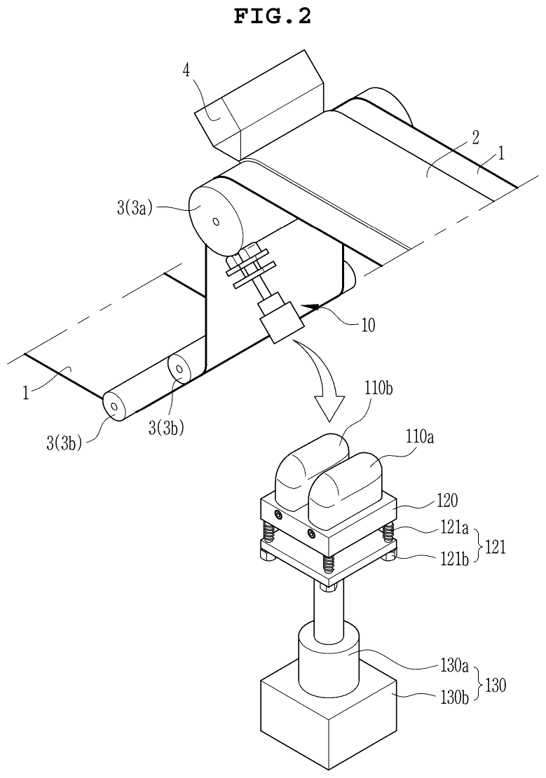

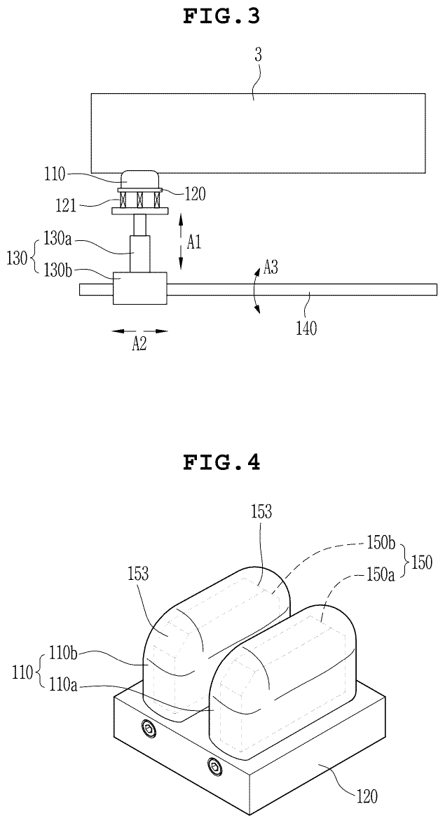

FIG. 1 is a view illustrating a roller cleaning apparatus 10 configured to clean a coating roller 3a according to an embodiment. FIG. 2 is a view illustrating a first pad 110a and a second pad 110b that are in contact with a surface of the coating roller 3a according to an embodiment. FIG. 3 is a view illustrating the roller cleaning apparatus 10 and a roller 3 according to an embodiment.

The roller cleaning apparatus 10 according to an embodiment may be used in a roll-to-roll type apparatus configured to manufacture an electrode of a battery cell. Such a roll-to-roll type apparatus may be configured to transfer a material, such as a current collector 1 wound on a roll, by using the roller 3 such as a coating roller 3a or a guide roller 3b. The roller 3 may further include rollers other than the coating roller 3a and the guide roller 3b. The roller cleaning apparatus 10 may be used for cleaning a surface of the coating roller 3a or a surface of the guide roller 3b.

A slit die 4 may apply a slurry 2 containing an active material to the current collector 1 supported by the coating roller 3a. In a process of applying the slurry 2 to the slit die 4, or in a process of transferring the slurry 2 through the roller 3 while the slurry 2 is in a state in which the slurry 2 is applied to the current collector 1, the slurry 2 may adhere to the surfaces of the rollers (for example, the coating roller 3a, the guide roller 3b, and so on). In this situation, foreign substances such as the slurry 2 that is attached to the surface of the roller 3 is required to be removed. When foreign substances such as the slurry 2 that is not completely dried, dust, and so on are attached to the surface of the roller 3, the foreign substances may be transferred to the current collector 1, or the current collector 1 may be damaged.

The roller cleaning apparatus 10 according to an embodiment may include the first pad 110a configured to be in contact with the surface of the roller 3 and to remove foreign substances, the second pad 110b configured to be in contact with the surface of the roller 3 while passing through an area through which the first pad 11a has passed from the surface of the roller 3, a head 120 configured to fix the first pad 110a and the second pad 110b such that the first pad 110a and the second pad 110b are spaced apart from each other by a predetermined distance, and a driving assembly 130 configured to move the head 120 to a portion of the roller 3 to which the foreign substances are attached.

In the roller cleaning apparatus 10, the surface of the roller 3 may be cleaned while the two pads 110 pass through the same area of the roller 3. The pad 110 may be brought into contact with the surface of the roller 3, thereby being capable of removing foreign substances attached to the surface of the roller 3. The pad 110 may include the first pad 110a that is firstly in contact with the surface of the roller 3, and may include the second pad 110b that is subsequently in contact with an area in which the first pad 110a contacts. The pad 110 may be formed of a soft material such that the pad 110 may not damage to the surface of the roller 3 even when the pad 110 is in contact with the surface of the roller 3.

The first pad 110a and the second pad 110b may be positioned in a row. The first pad 110a and the second pad 110b may be disposed parallel to each other along a circumferential direction in which the roller 3 is rotated. The roller 3 may be rotated, and the first pad 110a and the second pad 110b may maintain fixed positions. The surface of the roller 3 may pass through the first pad 110a, and may sequentially pass through the second pad 110b. Foreign substances attached to the surface of the roller 3 may be removed by the first pad 110a, and may be removed again by the second pad 110b.

The roller cleaning apparatus 10 may further include a third pad 110 positioned parallel to the first pad 110a and the second pad 110b. The third pad 110 is in contact with the surface of the roller 3 along the area through which the first pad 110a and the second pad 110b have passed, so that better removal of foreign substances may be realized. The roller cleaning apparatus 10 may include not only the third pad 110 but also a plurality of pads 110.

The roller cleaning apparatus 10 may further include a nozzle 161 configured to apply a cleaning solution toward the area through which the first pad 110a will pass, and may further include a cleaning solution supply unit 162 configured to supply the cleaning solution to the nozzle 161. The cleaning solution may include water, oil, a volatile solvent, a surfactant, and various other components. The component of the cleaning solution may be determined according to characteristics of foreign substances attached to the roller 3. The cleaning solution may be stored in a cleaning solution tank 163 of the cleaning solution supply unit 162, and may be provided to the nozzle 161 in an amount determined by a metering pump 164 of the cleaning solution supply unit 162.

The nozzle 161 may spray the cleaning solution toward the area where the roller 3 and the first pad 110a are in contact with each other. The area to which the nozzle 161 sprays the cleaning solution may include an area through which the first pad 110a will pass. The cleaning solution sprayed from the nozzle 161 may help the first pad 110a to remove foreign substances attached to the surface of the roller 3. The first pad 110a may remove foreign substances attached to the surface of the roller 3, and the second pad 110b following the area through which the first pad 110a has passed may remove the cleaning solution remaining on the surface of the roller 3. The second pad 110b may be formed of a material capable of absorbing the cleaning solution well compared to the first pad 110a.

The first pad 110a and the second pad 110b may be connected to the head 120. The head 120 may fix the first pad 110a and the second pad 110b so that the first pad 110a and the second pad 110b maintain predetermined positions with respect to the roller 3. A buffer part 121 may be connected between the head 120 and a first driving assembly 130a. The buffer part 121 may absorb vibration caused by rotation of the roller 3. The buffer part 121 may include a spring 121a and an adjustment part 121b. An operation range of the spring 121a is capable of being adjusted by rotating the adjustment part 121b. Even when the pad 110 and the surface of the roller 3 are in contact with each other strongly due to the vibration of the roller 3, the buffer part 121 may absorb shock. Accordingly, the rotation of the roller 3 may be stabilized, damage to the surface of the roller 3 may be prevented, and damage to the driving assembly 130 may be prevented.

The driving assembly 130 may include the first driving assembly 130a connected to the head 120 and configured to move the head 120 to a first direction toward the roller 3, and may include a second driving assembly 130b connected to the first driving assembly 130a and configured to be moved along a guide frame 140 that extends along a second direction that is a longitudinal direction of the roller 3. The roller cleaning apparatus 10 according to an embodiment may further include the guide frame 140 which supports the driving assembly 130 and which provides a path along which the driving assembly 130 moves.

The driving assembly 130 may move the head 120 so that the pad 110 is in contact with the surface of the roller 3 to which foreign substances are attached. The first driving assembly 130a may include an apparatus capable of moving the head 120 in the first direction. For example, the first driving assembly 130a may include a cylinder, a motor, a link structure, a gear, and so on. The first driving assembly 130a illustrated in FIG. 1 and FIG. 3 is a cylinder. A first end of the first driving assembly 130a is connected to the head 120, and a second end of the first driving assembly 130a is connected to the second driving assembly 130b, so that the head 120 is capable of being moved in the first direction (arrow A1 in FIG. 3). The cylinder may adjust a force pressing the pad 110 on the surface of the roller 3. By adjusting the cylinder, the cleaning strength for a portion determined in the desired area may be increased.

The second driving assembly 130b may be moved along the guide frame 140. The second driving assembly 130b may include a gear, a belt, a motor, a wheel, a roller, and so on. The guide frame 140 may be disposed parallel along the longitudinal direction of the roller 3. The guide frame 140 may be fixed to the ground surface or to another apparatus. The second driving assembly 130b may be moved along the guide frame 140 in the longitudinal direction of the roller 3 (arrow A1 in FIG. 3). When the second driving assembly 130b is moved in the longitudinal direction of the roller 3, the first driving assembly 130a connected to the first driving assembly 130a, the head 120, and the pad 110 may also be moved in the longitudinal direction of the roller 3. The second driving assembly 130b may clean all surfaces of the roller 3 by reciprocating opposite sides of the roller 3 for a predetermined period. The second driving assembly 130b may intensively clean the surface of the roller 3 by being fixed to an area where contamination frequently occurs.

The second driving assembly 130b may be rotated in a circumferential direction (arrow A3 in FIG. 3) of the guide frame 140 around a shaft of the guide frame 140. When the second driving assembly 130b is rotated, the first driving assembly 130a, the head 120, and the pad 110 may be rotated in the circumferential direction of the guide frame 140.

FIG. 4 is a view illustrating the pad 110 and a jig 150 according to an embodiment.

When the pad 110 is in contact with the surface of the roller 3 with a sufficient force, the foreign substances removal effect may be increased. Since the pad 110 is formed of a soft material, the pad 110 may be difficult to be in contact with the surface of the roller 3 with the sufficient force. The jig 150 may be inserted inside the pad 110 and may support the pad 110.

The first pad 110a may include a first jig 150a which is inserted inside the first pad 110a and which supports the first pad 110a, the second pad 110b may include a second jig 150b which is inserted inside the second pad 110b and which supports the second pad 110b, and the first pad 110a and the second pad 110b may be respectively detached from and attached to the first jig 150a and the second jig 150b.

The pad 110 may be formed of various materials such as fabric, a porous material, sponge, urethane foam, and so on. The pad 110 may have a first side provided with a receiving part into which the jig 150 is capable of being inserted. The pad 110 may be coupled to the jig 150 in a manner in which the pad 110 covers the jig 150 so that the jig 150 is inserted into the receiving part. The pad 110 may be fixed to the jig 150 by using an adhesive, a rubber ring, a string, and so on.

The jig 150 may be coupled to the head 120. The first jig 150a and the second jig 150b may be coupled to the head 120 such that the first jig 150a and the second jig 150b are disposed parallel to each other and spaced apart from each other. The jig 150 may be formed in a generally plate shape. The jig 150 may be formed such that a thickness of the jig 150 is sufficiently thick enough to support the pad 110 against a rotational force applied by the roller 3 to the pad 110. Upper and side portions of the jig 150 are processed so that corners and vertices are rounded, thereby being capable of preventing damage to the pad 110. Opposite sides of the upper portion of the jig 150 may have diagonal parts 153. The jig 150 having the diagonal part 153 may support the center of the pad 110 better than edges of the pad 110.

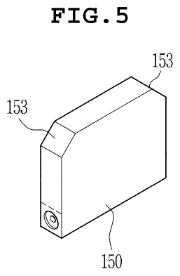

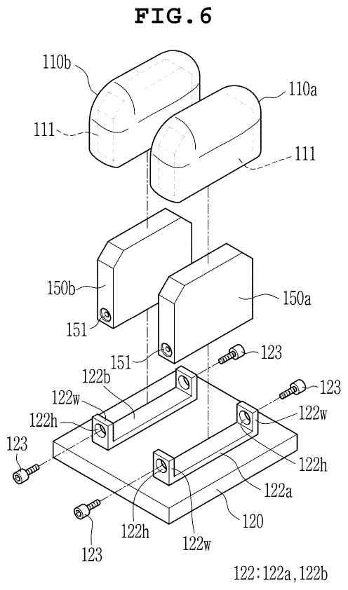

FIG. 5 is a view illustrating the jig 150 according to an embodiment. FIG. 6 is a view illustrating a coupling of the pad 110, the jig 150, and a jig mount 122 according to an embodiment.

Each of the first jig 150a and the second jig 150b may have each lower end thereof provided with a fastening groove 151 into which a fastener 123 is inserted. Furthermore, the head 120 may include a first jig mount 122a configured to fix the first jig 150a such that the first jig 150a is capable of being detached from and attached to the head 120, and may include a second jig mount 122b configured to fix the second jig 150b such that the second jig 150b is capable of being detached from and attached to the head 120.

The jig 150 may have the lower end thereof provided with the fastening groove 151 to couple the jig 150 to the head 120. The jig 150 may be coupled to the jig mount 122 of the head 120. The jig 150 and the jig mount 122 may be coupled to each other by using the fastener 123. The fastener 123 may be coupled to the fastening groove 151 of the jig 150 by passing through a through hole 122h formed in the jig mount 122. The fastener 123 may include a bolt or a screw, and the fastening groove 151 may be a groove in which a thread is formed.

The jig mount 122 may be a part of the head 120. The jig mount 122 may have a pair of fixing walls 122w that protrudes so as to cover the opposite sides of the jig 150. The through hole 122h for coupling the fastener 123 may be formed in each of the pair of fixing walls 122w. A lower portion of the jig 150 may be positioned between the pair of fixing walls 122w of the jig mount 122, the fastening groove 151 and the through hole 122h may be disposed side by side, and the fastener 123 may be inserted into the through hole 122h and the fastening groove 151. The pad 110 may be coupled to the jig 150 such that the pad 110 covers the jig 150.

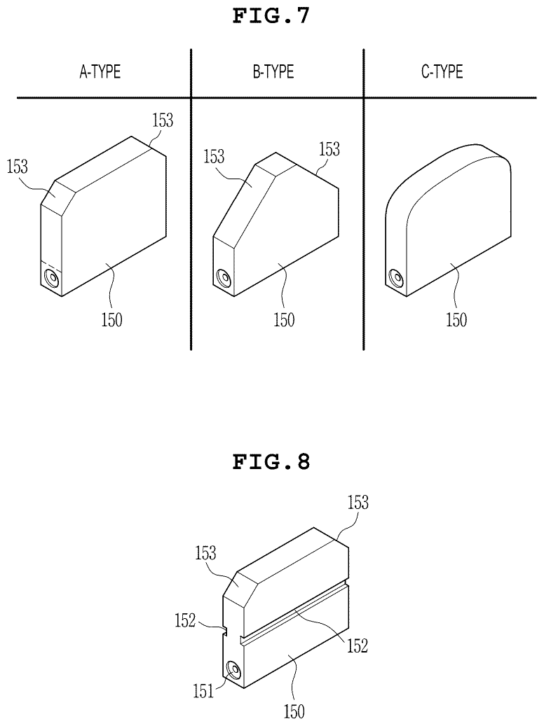

FIG. 7 is a view illustrating shapes of the jig 150 according to an embodiment.

The jig 150 may be provided in various types. An A-type jig 150 is the jig 150 illustrated in FIG. 5 and FIG. 6. The A-type jig 150 has a shape in which the diagonal part 153 is formed on each of the opposite sides of the upper portion of the jig 150. A B-type jig 150 has a shape in which each of the diagonal parts 153 on the opposite sides of the upper portion of the jig 150 is formed larger than the diagonal parts 153 in the A-type jig 150. Compared to the A-type jig 150, the B-type jig 150 is capable of providing more intensive support to the center of the pad 110. A C-type jig 150 has a shape in which the upper portion of the jig 150 is curved. In the C-type jig 150, a force supporting the pad 110 may be gradually reduced from the center of the pad 110 toward the edges of the pad 110.

In addition to the types illustrated in FIG. 7, various types of jigs 150 may be used. The jig 150 may be replaced according to surface characteristics of the roller 3 and characteristics of foreign substances. The A-type jig 150 may be coupled to the head 120 for removing A-type foreign substances, and the B-type jig 150 may be coupled to the head 120 for removing B-type foreign substances in other processes. When the jigs 150 are replaced, characteristics of the pad 110 cleaning the surface of the roller 3 may be changed.

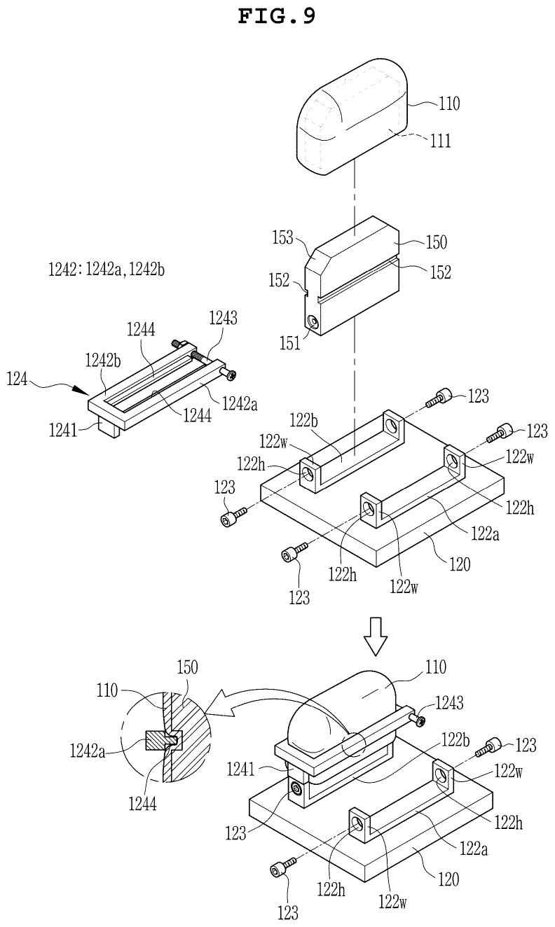

FIG. 8 is a view illustrating the jig 150 in which a trench 152 is formed according to an embodiment. FIG. 9 is a view illustrating a coupling of the pad 110, the jig 150, the jig mount 122, and a pressing part 124 according to an embodiment.

Each of the first jig 150a and the second jig 150b may have the trench 152 which is concave inwardly and which is parallel to a first surface of the head 120. The roller cleaning apparatus 10 may further include a first pressing part which is connected the first jig mount 122a and which has a protrusion part 1244 that protrudes toward the trench 152, the protrusion part 1244 being configured to push the first pad 110a toward an inside of the trench 152 and fix the first pad 110a by pressing the first pad 110a covering the first jig 150a. Furthermore, the roller cleaning apparatus 10 may further include a second pressing part which is connected the second jig mount 122b and which has the protrusion part 1244 that protrudes toward the trench 152, the protrusion part 1244 being configured to push the second pad 110b toward the inside of the trench 152 and fix the second pad 110b by pressing the second pad 110b covering the second jig 150b. FIG. 9 illustrates only one of the first pressing part and the second pressing part.

The trench 152 may be formed on side surfaces of the jig 150. The trench 152 may be a thin and long groove formed concave toward an inside of the jig 150. At least one trench 152 may be formed on wide opposite surfaces of the jig 150. The pressing part 124 may fix the pad 110 by pushing the pad 110 toward the trench 152, the pad 110 covering the wide opposite surfaces of the jig 150. When the pressing part 124 is not provided, the surface of the roller 3 and the pad 110 may come into frictional contact with each other due to the rotation of the roller 3 and the pad 110 may be separated from the jig 150, or the pad 110 may not apply a sufficient force to the surface of the roller 3. In a situation in which the pressing part 124 pushes and fixes the pad 110 to the jig 150, when the pad 110 is in contact with the surface of the roller 3, the problem that the pad 110 is separated from the jig 150 due to the rotation of the roller 3 or that the pad 110 is unable to apply the sufficient force to the surface of the roller 3 may be prevented.

The pressing part 124 may include a center body 1241 connected to the jig mount 122 of the head 120, a pair of arms 1242 that extends side by side from opposite ends of the center body 1241, and a distance adjustment part 1243 connected to each end of the pair of arms 1242 and configured to adjust a distance between the pair of arms 1242. The center body 1241 and the pair of arms 1242a and 1242b may be formed in a generally “⊏” shape.

The pressing part 124 may include the center body 1241 connected to the first jig mount 122a or the second jig mount 122b, the first arm 1242a and the second arm 1242b that extend along the trench 152 of the jig 150 from opposite sides of the center body 1241, the protrusion part 1244 which is formed on each of the surfaces of the first arm 1242a and the second arm 1242b facing each other and which protrudes toward the trench 152, and the distance adjustment part 1243 provided on each end of the first arm 1242a and the second arm 1242b and configured to adjust the distance between the first arm 1242a and the second arm 1242b. The first pressing part and the second pressing part may be formed in the same structure.

The center body 1241 may be connected to the fixing wall 122w of the jig mount 122. The center body 1241 may be formed integrally on the fixing wall 122w of the jig mount 122. The pair of arms 1242 may be connected to the opposite ends of the center body 1241. The pair of arms 1242 may include the first arm 1242a and the second arm 1242b. The first arm 1242a and the second arm 1242b may be formed parallel to each other. The first arm 1242a and the second arm 1242b may be formed longer than the width of the jig 150. The first arm 1242a and the second arm 1242b may be spaced apart from each other such that the jig 150 is capable of being positioned between the first arm 1242a and the second arm 1242b.

The distance adjustment part 1243 may be connected to each end of the first arm 1242a and the second arm 1242b. The distance adjustment part 1243 may include a bolt and a nut. The bolt and the nut are respectively connected to the end of the first arm 1242a and the end of the second arm 1242b, and may adjust the distance between the first arm 1242a and the second arm 1242b by rotating the bolt. A structure other than the bolt and the nut may be used in the distance adjustment part 1243.

Each protrusion part 1244 may be formed on each surface of the first arm 1242a and the second arm 1242b facing each other. The protrusion part 1244 may protrude toward the trench 152. The protrusion part 1244 may be formed such that the protrusion part 1244 is thinner than the trench 152 and has a length corresponding to that of the trench 152. The protrusion part 1244 may push the pad 110 toward the inside of the trench 152 when the first arm 1242a and the second arm 1242b are moved close together. When the distance adjustment part 1243 adjusts the distance between the first arm 1242a and the second arm 1242b to be narrow, the pad 110 is pressed and fixed between the protrusion part 1244 and the trench 152, so that the pad 110 may be more tightly fixed to the jig 150. Therefore, even when the roller 3 is rotated at a high speed and comes into frictional contact with the pad 110, a state in which the pad 110 is tightly fixed to the jig 150 may be maintained.

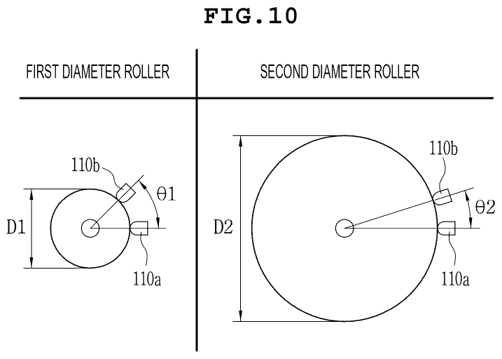

FIG. 10 is a view illustrating a relationship between angles of the first jig 150a and the second jig 150b and a diameter of the roller 3 according to an embodiment.

An angle between the surface of the roller 3 and the pad 110 effective for cleaning the surface of the roller 3 may exist. For example, the pad 110 may be positioned in a direction parallel to a radial direction with respect to the center of the roller 3. A distance between the first pad 110a and the second pad 110b effective for cleaning the surface of the roller 3 may exist. The distance between the first pad 110a and the second pad 110b may be determined on the basis of a type of foreign substances, a diameter of the roller 3, a rotation speed of the roller 3, and so on.

When the diameter of the roller 3 is small, the angle between the first pad 110a and the second pad 110b, i.e., the angle between the first jig 150a and the second jig 150b may be determined to have a large angle. When the diameter of the roller 3 is large, the angle between the first pad 110a and the second pad 110b, i.e., the angle between the first jig 150a and the second jig 150b may be determined to have a small angle. For example, in FIG. 10, the angle between the first jig 150a and the second jig 150b corresponding to the roller 3 having a first diameter D1 may be larger than the angle between the first jig 150a and the second jig 150b corresponding to the roller 3 having a second diameter D2.

Alternatively, the angle between the first jig 150a and the second jig 150b may be determined regardless of the diameter of the roller 3.

In the roller cleaning apparatus 10 according to an embodiment, the angle between the first jig 150a and the second jig 150b may be adjusted in order to use the roller cleaning apparatus 10 to the rollers 3 having various diameters.

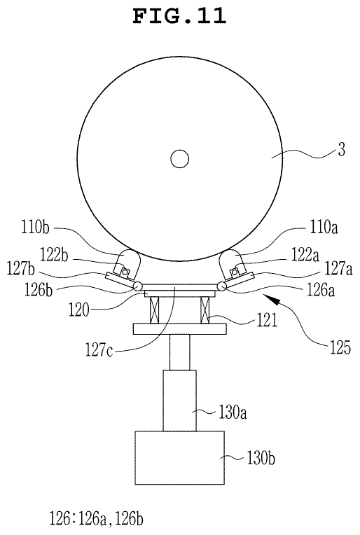

FIG. 11 is a view illustrating the head 120 configured to adjust an angle by using a hinge according to an embodiment.

The roller cleaning apparatus 10 may further include an angle adjustment part 125 connected to the first jig mount 122a and the second jig mount 122b and configured to adjust an angle of the first jig 150a and an angle of the second jig 150b with respect to the roller 3. The angle adjustment part 125 may be connected to the head 120.

The angle adjustment part 125 may include a first hinge 126a configured to adjust an angle of the first jig mount 122a so as to adjust an angle at which the first jig 150a faces the roller 3, and may include a second hinge 126b configured to adjust an angle of the second jig mount 122b so as to adjust an angle at which the second jig 150b faces the roller 3.

The angle adjustment part 125 may include a first plate 127a connected to the first hinge 126a and connected to the first jig mount 122a, a second plate 127b connected to the second hinge 126b and connected to the second jig mount 122b, and a third plate 127c having opposite sides connected to the first hinge 126a and the second hinge 126b and being connected to the head 120. Each angle of the first plate 127a and the second plate 127b may be adjusted by adjusting the first hinge 126a and the second hinge 126b with respect to the third plate 127c connected to the head 120.

The angle adjustment part 125 may adjust each angle of the first jig 150a and the second jig 150b by adjusting the first jig mount 122a and the second fixing part 122b. The angle adjustment part 125 may adjust an angle of the first hinge 126a connected to the first jig mount 122a, and may adjust an angle of the second hinge 126b connected to the second jig mount 122b. An angle between the first jig 150a and the second jig 150b may be adjusted by adjusting the first hinge 126a and the second hinge 126b.

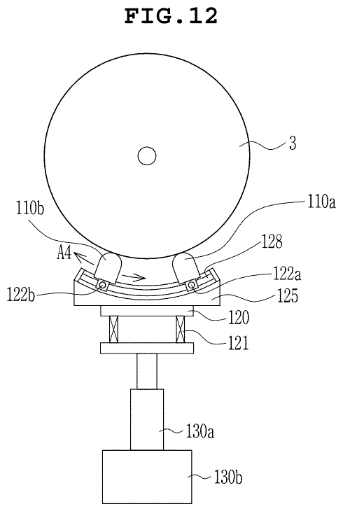

FIG. 12 is a view illustrating the head configured to adjust an angle by using a rail 128 according to an embodiment.

The angle adjustment part 125 of the head 120 may further include the rail 128 curvedly formed along the circumferential direction of the roller 3. The first jig mount 122a and the second jig mount 122b may be coupled to the rail 128 such that the first jig mount 122a and the second jig mount 122b are capable of being moved along the rail 128 and are capable of being fixed to the rail 128. The rail 128 may be coupled to the angle adjustment part 125 or may be formed on a first surface of the angle adjustment part 125.

The jig mount 122 may be formed in a structure in which the jig mount 122 is configured to be slid (arrow A4) along the rail 128, and may include a bolt and so on for fixing the jig mount 122 to the rail 128. The first jig mount 122a and the second jig mount 122b may be moved along one rail 128. The angle between the first jig 150a and the second jig 150b may be determined according to the curvature of the rail 128. The distance between the first jig 150a and the second jig 150b may be determined according to which position the first jig mount 122a and the second jig mount 122b are fixed to on the rail 128.

The rail 128 may be formed in a curved shape such as a circle, a parabola, an ellipse, and so on. The rail 128 may be formed such that opposite ends of the rail 128 have curves toward the roller 3. The rail 128 may be formed such that the curvature of some areas and the curvature of some other areas are different from each other. The rail 128 may be formed such that the rail 128 has two or more portions having different curvatures.

For example, a middle portion of the rail 128 may have a large curvature, and edge portions of the rail 128 may have small curvatures. When the first jig mount 122a and the second jig mount 122b are fixed to the middle portion of the rail 128, the angle between the first jig 150a and the second jig 150b may be large, and the distance between the first jig 150a and the second jig 150b may be close. When the first jig mount 122a and the second jig mount 122b are fixed to edge portions of the rail 128, the angle between the first jig 150a and the second jig 150b may be small, and the distance between the first jig 150a and the second jig 150b may be large.

When the angle and the distance between the first pad 110a and the second pad 110b are adjusted in consideration of the type of foreign substances, the diameter of the roller 3, and so on, foreign substances attached to the surface of the roller 3 may be more easily removed, and the roller cleaning apparatus 10 may be used on various types of rollers 3.

According to an embodiment described above, two or more pads 110 are used, the cleaning solution is sprayed, the jig 150 supports the pad 110, and the angle of the pad 110 is capable of being adjusted, so that foreign substances on the coating roller 3a are capable of being easily removed, thereby being capable of increasing the operation rate of manufacturing facility. In addition, in the roller cleaning apparatus 10, since the pad 110 is capable of being fixedly positioned at a predetermined position, a portion of the roller 3 where the contamination of the roller 3 is repeated is capable of being continuously cleaned.

The technology of the present disclosure has been described in detail through specific embodiments. The contents described above are only examples of applying the principles of the technology of the present disclosure, and other configurations may be further included within the scope of the present disclosure.

What is claimed is:

1. A roller cleaning apparatus comprising:
a first pad configured to remove foreign substances by being in contact with a surface of a roller;
a second pad configured to be in contact with the surface of the roller while passing through an area through which the first pad has passed from the surface of the roller;
a head configured to fix the first pad and the second pad such that the first pad and the second pad are spaced apart from each other by a predetermined distance; and
a driving assembly configured to move the head to a portion of the roller to which foreign substances are attached.

2. The roller cleaning apparatus of claim 1, further comprising:
a nozzle configured to apply a cleaning solution toward an area through which the first pad will pass; and
a cleaning solution supply unit configured to supply the cleaning solution to the nozzle.

3. The roller cleaning apparatus of claim 1, wherein the driving assembly comprises:
a first driving assembly connected to the head and configured to move the head in a first direction toward the roller; and
a second driving assembly connected to the first driving assembly and configured to be moved along a guide frame that extends in a second direction which is a longitudinal direction of the roller.

4. The roller cleaning apparatus of claim 1, wherein the first pad comprises a first jig which is inserted inside the first pad and which supports the first pad, the second pad comprises a second jig which is inserted inside the second pad and which supports the second pad, and the first pad and the second pad are coupled to the first jig and the second jig such that the first pad and the second pad are capable of being attached to and detached from the first jig and the second jig.

5. The roller cleaning apparatus of claim 4, wherein each of the first jig and the second jig has each lower end thereof provided with a fastening groove into which a fastener is inserted, and
the head comprises:
a first jig mount configured to fix the first jig such that the first jig is capable of being attached to and detached from the first jig mount; and
a second jig mount configured to fix the second jig such that the second jig is capable of being attached to and detached from the second jig mount.

6. The roller cleaning apparatus of claim 5, wherein each of the first jig and the second jig has a trench that is concave inwardly and parallel to a first surface of the head, and
the roller cleaning apparatus further comprises:
a first pressing part which is connected to the first jig mount and which has a protrusion part that protrudes toward the trench, the protrusion part being configured to press the first pad covering the first jig, thereby fixing the first pad by pushing the first pad toward an inside of the trench; and
a second pressing part which is connected to the second jig mount and which has a protrusion part that protrudes toward the trench, the protrusion part being configured to press the second pad covering the second jig, thereby fixing the second pad by pushing the second pad toward the inside of the trench.

7. The roller cleaning apparatus of claim 6, wherein the first pressing part or the second pressing part comprises:
a center body connected to the first jig mount or the second jig mount;
a first arm and a second arm that extend along the trench of the first jig or the second jig from opposite sides of the center body;
the protrusion part which is formed on a surface of the first arm and a surface of the second arm that are facing each other and which protrudes toward the trench; and
a distance adjustment part formed on an end of the first arm and an end of the second arm and configured to adjust a distance between the first arm and the second arm.

8. The roller cleaning apparatus of claim 5, further comprising:
an angle adjustment part connected to the first jig mount and the second jig mount and configured to adjust an angle of the first jig and an angle of the second jig with respect to the roller.

9. The roller cleaning apparatus of claim 8, wherein the angle adjustment part comprises:
a first hinge configured to adjust an angle of the first jig mount so as to adjust an angle at which the first jig faces the roller; and
a second hinge configured to adjust an angle of the second jig mount so as to adjust an angle at which the second jig faces the roller.

10. The roller cleaning apparatus of claim 8, wherein the angle adjustment part further comprises a rail formed curvedly along a circumferential direction of the roller, and the first jig mount and the second jig mount are coupled to the rail such that the first jig mount and the second jig mount are capable of being moved along the rail and are capable of being fixed to the rail.

11. The roller cleaning apparatus of claim 10, wherein the rail is formed such that a curvature of some areas of the rail and a curvature of some other areas of the rail are different from each other.
